(19) United States
(12) Patent Application Publication
(10) Pub. No.: US 2009/0162649 A1
(43) Pub. Date: Jun. 25, 2009

(54) PROCESS FOR PRODUCING POROUS SHAPED BODIES

(76) Inventors: Arno Tissler, Tegernheim (DE); Volker Kurth, Bad Aibling (DE); Attila Jambor, Prien (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/092,028

(22) PCT Filed: Oct. 31, 2006
(86) PCT No.: PCT/EP06/10486

§ 371 Date: Aug. 6, 2008

(30) Foreign Application Priority Data
Oct. 31, 2005 (DE) 10-2005-052-016.2

(51) Int. Cl. B32B 3/10; B29C 44/00

(52) U.S. Cl. 428/338; 264/54

(57) ABSTRACT

The present invention relates to a process for producing a catalytically active porous shaped body, which comprises the steps: a) provision of a catalytically active powder consisting essentially of particles having a defined internal porosity, b) intimate mixing of the powder with a ball-shaped or spherical inelastic pore former and/or a binder, c) shaping of the mixture from step b) to form a shaped body, d) calcination of the shaped body obtained in step c). The invention further relates to a shaped body produced by the process of the invention.

The shaping of powders to shaped bodies which have particular desired properties, for example a high pore volume, a high mechanical stability, etc, constitutes a great challenge especially in the field of production of solid catalysts.

This relates especially to shaped bodies formed from catalytically active powders which, for example, already have a so-called “inherent porosity”, for example zeolites, clay materials, for example pseudoboehmite, etc. An “inherent porosity”—or in other words the intrinsic pore volume of such materials which have pores by their nature—can be measured by means of customary processes known to those skilled in the art, for example mercury porosimetry.

A high pore volume is advantageous for a rapid conversion of the reaction mixture over the catalyst, while a high mechanical stability is required for technical reasons, in order that a very low level of catalyst attrition and hence, in particular, a pressure drop, for example, is caused during the catalytic process.

The two most important properties of such shaped bodies which are needed for successful catalysis, specifically the optimal pore volume and the optimum mechanical stability, are not always satisfied simultaneously in one shaped body. Often, shaped bodies with a high pore volume have a low mechanical stability, and shaped bodies with a high mechanical stability generally have a low pore volume.

In general, in the prior art, a compromise is therefore made between the two parameters with regard to their optimal values.

It is known that high pore volumes of such shaped catalyst bodies can be obtained by adding organic combustible substances such as cellulose, flour, oil, etc. during the shaping process of the shaped body (DE 102 19 879 A1). In general, these shaped bodies are obtained by extruding suitable mixtures of starting materials. Calcination of the extrudates removes these organic additives and, after they have been burnt out, leaves behind voids or pores which reduce the mechanical stability of the shaped bodies.

However, such organic additives have the disadvantage that they do not always burn without residue, especially when amorphous carbon is used, such that the calcined shaped bodies therefore often have to be aftertreated in a complicated manner, in order to remove the residues of the organic additives after the calcination.

It is therefore an object of the present invention to provide a process for producing porous shaped bodies which combine a high pore volume with a high mechanical stability. It is a further object to avoid an aftertreatment of the porous shaped bodies obtained by the process according to the invention.

This object is achieved in accordance with the invention by a process for producing a porous shaped body, comprising the steps of
a) providing a powder consisting essentially of particles with a defined internal porosity
b) intimately mixing the powder with an inelastic pore former having a spheroidal or spherical shape
c) shaping the mixture from step b) to a shaped body
d) calcining the shaped body obtained in step c).

By virtue of the addition of an inelastic pore former, it is possible, for example, to increase the pressure in the shaping process, which is preferably carried out in an extruder, such that any water or solvent present in the mixture for extrusion can be pressed out of the mold, but the transport pores or the larger pores are not closed by the pressure applied, since the inelastic pore formers withstand the pressure existing in the extruder.

In accordance with the invention, the term “inelastic pore former” shall thus be understood to the effect that it can withstand an external pressure without being pressed out of the mold. The expression “defined internal porosity” means that the internal porosity which is present per se in such particles (starting materials) can be determined exactly and is not zero, but is also less than 0.5 cm³/g, preferably 0.4 cm³/g and even more preferably 0.2 cm³/g.

After the shaping, the inelastic pore former is removed by calcination to form a porous shaped body having a high pore volume of more than 0.5 cm³/g. At the same time, the porous shaped body produced by the process according to the invention also has a mechanical stability of >1.7 kg per cm, since a high pressure can advantageously be achieved in the extruder, but pores likewise form as a result of the use and subsequent calcination of inelastic pore formers.

Preferably, step b) of the process according to the invention is preceded by production of an aqueous slurry of the powder from step a), which considerably eases the subsequent further processing.

According to the invention, the inelastic pore former surprisingly burns without residue during the calcination. This avoids complicated aftertreatment steps of the porous shaped body obtained by the process according to the invention. This also leads to a lower level of coking in the shaped body thus obtained during use in a catalytic process than conventional shaped bodies which are obtained by the use of organic pore formers, such that the lifetime in the catalytic cycles until the regeneration of the inventive catalytic shaped body is higher, and lower regeneration cycles at greater time intervals are required compared to conventionally produced shaped bodies.

The inelastic pore former preferably consists of essentially spherical resin or polymer particles, for example polystyrenes or polystyrene resins, polyurethanes, polypropylene or polypropylene resins, polyethylene, polypropylene-polyethylene copolymers or polypropylene-polyethylene resins. Other geometric shapes are of course likewise usable in the context of the invention, but they are more difficult to produce in production terms. In a preferred manner, resin particles which have a mean diameter of from 0.5 to 2 μm, more preferably of from 0.7 to 1.5 μm, are employed. In this connection, the term “resin” is understood such that it comprises substantially amorphous polymeric products without a sharp softening or melting point.

In a particularly preferred further embodiment, the spherical resin particles form essentially spherical agglomerates with a particle diameter of such agglomerates of from 10 to 100 μm. The spherical resin particles form more or less regular substructures in this agglomerate. The term “spherical” in the present context is understood in a topological sense and encompasses figures which can be defined in space by means of spherical coordinates, i.e., for example, also cubic objects, distorted spheres, egg-shaped figures, etc.

The inelastic pore former is preferably added by means of a binder to a preferably aqueous slurry of the powder in step b) of the process according to the invention and mixed intimately.

The amount of inelastic pore former based on the solids content of the aqueous slurry is between 1 and 30% by weight, preferably between 5 and 20% by weight, more preferably between 10 and 15% by weight. The amount of the binder likewise to be added optionally is, based on the solids content of the aqueous slurry, between 50 and 80% by weight, preferably between 10 and 70% by weight, more preferably between 15 and 60% by weight, in order to achieve a high setting capacity of the shaped body obtained in accordance with the invention. Furthermore, to the binder, acrylic resins such as acrylates, acrylamides, acrylonitriles, etc. can also be added to increase the strength of the shaped body in an amount of from 0.1 to 30% by weight based on the solids content of the aqueous slurry.

The inventive mixture thus obtained is preferably shaped by extrusion, since the pressure in the extruder can be set particularly efficiently, such that particularly mechanically stable and durable shaped bodies are obtained.

The calcination temperature in the course of calcination of the shaped body in the process according to the invention is generally between 400 and 600° C. Below 400 to in some cases—according to the pore former—even approx. 450° C., the binder and/or further additives and the inelastic pore former are generally not burnt out or converted completely; above approx. 600° C., there is the risk that the porous material, i.e. preferably a molecular sieve, for example a zeolite, aluminum phosphate, etc is damaged by thermal stress. Its catalytic performance in the shaped body thus falls. However, it is emphasized that a temperature of more than 600° C. can also quite possibly be used briefly in accordance with the invention, in order to completely burn out any last residues. However, temperatures in the temperature range between 600 and 700° C. should not act on the shaped body obtained in accordance with the invention for too long a period, in order to rule out thermally induced damage to the shaped body, and hence a worsened catalytic activity from the outset.

Preferably, in a first step, the powder with a defined porosity is mixed with a sol-gel colloid, for example silicon dioxide. It is very particularly preferred that the sol-gel is essentially alkali metal-free, i.e. contains less than 0.1% by weight of alkali metal compounds. Although it is also possible to use alkali metal-containing sol-gels, an additional aftertreatment of the calcined shaped body, for example with HNO₃, is required in this case, in order to carry out an alkali metal exchange in the inventive shaped body. Another important factor in the case of addition of the sol-gel is the size of the primary particles, which should generally be within a range of 10-20 nm.

The object of the present invention is also achieved by a catalytically active shaped body prepared by the process according to the invention. This shaped body has a porosity of >0.15 cm³/g, preferably >0.35 cm³/g, more preferably >0.45 cm³/g, and a high mechanical stability of >1.7 kg/cm².

The inventive shaped body has, based on the total volume, for pores having a diameter of from 7.5 nm to 15 000 nm, the percentage distribution of the proportions of pores with different pore diameters specified in table 1 below. This distribution firstly guarantees an optimal porosity for performing the catalytic reaction, and secondly also enables the required strength of the shaped bodies:

TABLE 1
Typical pore size distribution in a shaped body
produced in accordance with the invention

| | |
|---|---|
| Pore diameter | Percentage |

| | | |
|---|---|---|
| 7.5-14 | nm | 5-15 |
| 14-80 | nm | 8-35 |
| 80-1750 | nm | 55-85 |
| 1750-15 000 | nm | 0.1-2 |

Particularly preferred proportions are 7-12% for pores having a pore diameter of 7.5-14 nm, most preferably 7.5-10%, 12-29% for pores of pore diameter 14-80 nm, most preferably 15-25%, 60-80% for pores having a pore diameter of 80-1750 nm, most preferably 65-75%, and 0.3-1.5% for pores having a pore diameter of 1750-15 000 nm, most preferably 0.5-1%.

The process according to the invention will be illustrated hereinafter with reference to a working example which should not be interpreted in a restrictive manner.

### WORKING EXAMPLE

The catalytically active powder used with an internal defined porosity was the zeolite NH₄-MFI 500. 2.5 kg of the zeolite were mixed with 1.6 l of demineralized water to give a slurry, and 1.563 kg of colloidal silicon dioxide (Ludox HS40) were added. In addition, 50 g of methylcellulose (Methocel F4M) were added, as were, as an inelastic pore former, 500 g of a polystyrene resin (Almatex Muticle PP 600 with a particle diameter of 0.8 μm). In addition, 50 g of an acrylonitrile resin (Dualite E135-040D) were added. The mixture was mixed intensively and extruded in an extruder (Fuji, Pandal Co., Ltd., Japan) to give catalytically active shaped bodies and then dried under air at a temperature of 120° C. for three hours. Subsequently, the shaped bodies were calcined by increasing the temperature to 550° C. at a heating rate of 60° C./hour, and this temperature was maintained for five hours. Finally, the shaped bodies were cooled again to room temperature.

If alkali metal is not excluded from the process, the extrudates can optionally be aftertreated with nitric acid to lower the alkali metal content as follows:

18 188 g of demineralized water were admixed with nitric acid (52.5%) until a pH of 2 had been attained. The dilute acid was heated to 80° C., the extrudates (2500 g) were added and the mixture was kept at 80° C. for 5 hours. The pH of the acid was monitored continuously and, if a pH of 2 was exceeded, fresh nitric acid was added until pH 2 had been attained. Consumption: 29 g of HNO₃ (52.5%). After 5 hours, the extrudates were washed repeatedly with 7500 g of demineralized H₂O down to a conductivity of the wash water of <100 μs. Subsequently, the extrudates were again added to dilute nitric acid at pH=2 heated to 80° C. for 5 hours and the pH of the acid was kept at pH=2 by adding fresh nitric acid.

Consumption: 19.8 of HNO₃ (52.5%). The extrudates were washed repeatedly with 7500 g of demineralized H₂O down to a conductivity of the wash water of <100 μs. Drying and calcination were effected as above (120° C.→60° C./h→550° C. for 5 hours→cooling).

The analysis of the shaped body gave the results reported in the table below. The pore volume (porosity) (PV) was determined by means of mercury porosimetry to DIN 66133 at a maximum pressure of 2000 bar.

TABLE 2
Physical properties of the shaped body
according to the working example:

Shaped body according to the
working example

| Form | | | | 1/16″ extrudate |
|---|---|---|---|---|
| Binder | | | | Silica |
| Binder content | | | (% by wt.) | 20 |
| LOI | | a) | (% by wt.) | 1.4 |
| Na | | b) | (ppm by wt.) | <40 |
| C | | b) | (ppm by wt.) | 70 +/− 20 |
| Hardness | | | (kg/cm²) | 1.9 |
| PV (Hg) | | | (cm³/g) | 0.54 |
| Pore size distribution: | | | | |
| >1750 | nm | | (%) | 0.71 |
| 1750-80 | nm | | (%) | 68.96 |
| 80-14 | nm | | (%) | 21.5 |
| 14-7.5 | nm | | (%) | 8.83 |

| | | | |
|---|---|---|---|
| APR | | (nm) | |
| SA | g) | (m²/g) | 295 |

a) 1000° C./3 h
b) As in the sample
g) BET surface area to DIN 66131, 5-point process: p/po = 0.004-0.14; conditioning: 350° C./3 h under reduced pressure.
LOI = loss on ignition (weight loss in the course of calcination)

1. A process for producing a catalytically active porous shaped body, comprising the steps of
a) providing a catalytically active powder consisting of particles with a defined internal porosity
b) intimately mixing the powder with a spheroidal or spherical inelastic pore former
c) shaping the mixture from step b) to a shaped body
d) calcining the shaped body obtained in step c).

2. The process as claimed in claim 1, wherein a polymer or a copolymer composed of polypropylene, polyethylene, polyurethane, polystyrene and/or mixtures thereof is used as the inelastic pore former.

3. The process as claimed in claim 2, characterized in that step b) is preceded by production of an aqueous slurry of the powder from step a).

4. The process as claimed in claim 3, characterized in that the inelastic pore former is added in an amount of from 1 to 30% by weight based on the solids content of the aqueous slurry.

5. The process as claimed in claim 1, characterized in that the shaping is effected by extrusion.

6. The process as claimed in claim 1, characterized in that the calcination is effected in step d) at a temperature between 450° C. and 600° C., more preferably between 500 and 600° C.

7. The process as claimed in claim 1, characterized in that a binder is also added before, during or after step b).

8. The process as claimed in claim 7, characterized in that the binder is added in an amount of 5-80% by weight based on the solids content of the aqueous slurry.

9. The process as claimed in claim 8, characterized in that the binder contains less than 0.1% by weight of alkali metal compounds.

10. A shaped body obtainable by the process as claimed in claim 1.

11. The shaped body as claimed in claim 10, characterized in that the shaped body has a pore volume of >0.5 cm³/g.

12. The shaped body as claimed in claim 10, characterized in that the shaped body has a mechanical stability of >1.7 kg/cm².
